(19) United States
(12) Patent Application Publication
(10) Pub. No.: US 2011/0164409 A1
(43) Pub. Date: Jul. 7, 2011

(54) HIDEAWAY HOLIDAY LIGHTING SYSTEMS

(76) Inventors: Lance Smith, Marysville, CA (US); Jose Compos, Olivehurst, CA (US)

(21) Appl. No.: 12/984,603

(22) Filed: Jan. 5, 2011

Related U.S. Application Data
(60) Provisional application No. 61/292,657, filed on Jan. 6, 2010.

(51) Int. Cl. F21S 8/00; B23P 11/00

(52) U.S. Cl. 362/145; 29/428

(57) ABSTRACT

Hideaway holiday lighting systems comprises a retractable bar for hanging holiday lights assembly. The retractable bar assembly includes a plurality of strings of holiday lights attached thereto; and at least one hinge mechanism coupled to the retractable bar permitting the retractable bar to be manipulated between concealed-up and display-down positions. The retractable bar is removably secured behind rain gutters and fascia boards of a building for automatically displaying of the plurality of strings of holiday lights when in the display-down position. The hinge mechanism is able to be repeatedly manipulated by a user between the display-down position, for at least one display-use during the holiday season thereby displaying the plurality of strings of holiday lights for illumination-decorative purposes, and the concealed-up position thereby concealing the retractable bar for the remainder of the season in a non-use environmentally-protected location.

### CROSS-REFERENCE TO RELATED APPLICATION

The present application is related to and claims priority from prior provisional application Ser. No. 61/292,657, filed Jan. 6, 2010 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

1. Field of the Invention

The present invention relates generally to the field of illumination and more specifically relates to hideaway holiday lighting systems.

2. Description of the Related Art

The use of decorative, festive lighting during the Christmas holiday season is a long standing tradition in many Christian cultures, and has been adopted as a secular practice in a number of other non-Christian cultures. Typically, Christmas lights are strands of electric lights used to decorate homes, public/commercial buildings and Christmas trees during the Christmas season which come in a dazzling array of configurations and colors. The types of lamps used in Christmas lighting may also vary considerably, reflecting the diversity of modern lighting

Every year, a significant number of consumers struggle with ladders, staple guns and tangled strands of holiday lights to decorate their home and/or office. It can be a time-consuming and sometimes frustrating endeavor for an individual to properly install holiday lights, only for the installer to have to take them down a few weeks later storing the lights until the process is repeated the following year. The lights are not normally left out during the remainder of the year because UV rays degrade the bulbs, making them brittle and removing their color. Repeated yearly installations may leave staple holes in the finish of the house's exterior creating compromises that may cause the house to deteriorate. Additionally, the potential of falling from elevated positions when hanging such lights is an inevitable reality. Therefore a need exists to reduce the hassle of installing and removing holiday lights every holiday season.

Various attempts have been made to solve the above-mentioned problems such as those found in U.S. Pat. and Pub. Nos. 2003/0235053; 4,128,863; 5,404,279; 5,311,414; 5,813,751; and 6,474,840. This prior art is representative of holiday light hangers and/or mounting systems. None of the above inventions and patents, taken either singly or in combination, is seen to describe the invention as claimed.

Ideally, a hideaway holiday lighting should be user-friendly to install and, yet, would operate reliably and be manufactured at a modest expense. Thus, a need exists for reliable hideaway holiday lighting systems to automatically display holiday lights when in a display-down position and to protect the lights when in a concealed up position and avoid the above-mentioned problems.

### BRIEF SUMMARY OF THE INVENTION

In view of the foregoing disadvantages inherent in the known holiday light art, the present invention provides a novel holiday hideaway lighting system. The general purpose of the present invention, which will be described subsequently in greater detail is to provide a device that eliminates the need to install and remove holiday lights every single year. This unique device enables users to install beautiful strands of lights onto a retractable light bar that fits snugly to the back of fascia and gutters of a building. During the holiday season, the light bar can be flipped down to expose the light display. When the season is over, users simply flip the bar back up, placing it in the locked position where it will remain out of sight, thereby protected until the following year.

The present retractable bar for hanging holiday lights assembly disclosed herein preferably comprises the following components: at least one retractable bar having a plurality of strings of holiday lights attached thereto; at least one hinge mechanism; at least one electrical outlet; at least one switch; at least one electrical motor; at least one preferably plastic (or other-wise suitable weather-resistant material) mountable frame; and a plurality of L-shaped attaching members.

The retractable bar is removably secured behind rain gutters and fascia boards of a building for automatically displaying the plurality of strings of holiday lights when in a display-down position. Further, the retractable bar may comprise two channel bars with slots. The slots comprise through hole apertures wherein fasteners to retain the strings of holiday lights are securable therethrough. In the present invention, light strings may be run through the interior of the channel bar (using it as a conduit) or outside, as shown. The slots are approximately ⅛-inch by 9⅙-inch long cuts approximately every ¼-inch along a length of said channel bar(s). The retractable bar is lockable into a concealed-up position or into a display-down position. Channel bars also comprise mounting apertures used to fasten them to the fascia and gutters of a building via screws or other suitable fastening means.

The hinge mechanism is preferably coupled to the retractable bar permitting the retractable bar to be manipulated between concealed-up and display-down positions. The hinge mechanism may comprise at least one pull release in certain embodiments. The hinge mechanism is able to be repeatedly manipulated by a user between the display-down position, for at least one display-use during the holiday season thereby displaying the plurality of strings of holiday lights for illumination-decorative purposes, and the concealed-up position thereby concealing the retractable bar for the remainder of the year in a non-use environmentally-protected location. Additionally, the hinge mechanism provides a rotating centerline whereby the retractable bar is rotatable between the concealed-up and the display-down positions. An electrical motor is included in certain embodiments and is used to manipulate the hinge mechanism upon activation. At least one L-shaped attaching member may be used for attaching the retractable bar to the rain gutters and/or the fascia boards, helping to distribute the load.

A kit is embodied herein for the hideaway holiday lighting systems comprising: a retractable bar assembly for hanging holiday lights; at least one hinge mechanism; a mountable frame; fasteners; a light holding bag; hanging holiday lights; and a set of user instructions.

In accordance with the embodiments of the present invention a preferred method of use is disclosed herein comprising the steps of: removably securing at least one retractable bar behind rain gutters and fascia boards of a building for automatically displaying a plurality of holiday lights during at least one festive season; flipping and thereby unstowing the retractable bar in a display-down position during the festive season thereby illumination-displaying the plurality of holiday lights; and flipping the retractable bar back up into a stowed storage position thereby concealing the retractable bar for a remainder of the year in a non-use position. In embodiments using LED icicle lights, these lights may be stowed in a storage bag enclosed with hoop and loop fasteners to prevent environmental and impact damage during non-use periods.

The present invention holds significant improvements and serves as a hideaway holiday lighting system(s). For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, hideaway holiday lighting systems, constructed and operative according to the teachings of the present invention.

FIG. 1 shows a perspective view illustrating a hideaway holiday lighting system in a concealed-up position condition according to an embodiment of the present invention.

FIG. 2 is a perspective view illustrating the hideaway holiday lighting system in a display-down position according to an embodiment of the present invention of FIG. 1.

FIG. 3 is a perspective view illustrating a retractable bar for hanging holiday lights according to an alternate embodiment of the present invention of FIG. 1.

FIGS. 4a-4g show perspective views illustrating various embodiments of the present invention of FIG. 1.

FIG. 5 is a perspective view illustrating another alternate embodiment having an electrical motor according to an embodiment of the present invention of FIG. 1.

FIG. 6. is a flowchart illustrating a method of use for the hideaway holiday lighting system according to an embodiment of the present invention of FIGS. 1-5.

The various embodiments of the present invention will hereinafter be described in conjunction with the appended drawings, wherein like designations denote like elements.

### DETAILED DESCRIPTION

As discussed above, embodiments of the present invention relate to an illumination device and more particularly to a hideaway holiday lighting system as used to improve the convenience of displaying holiday lights during festive seasons, season after season.

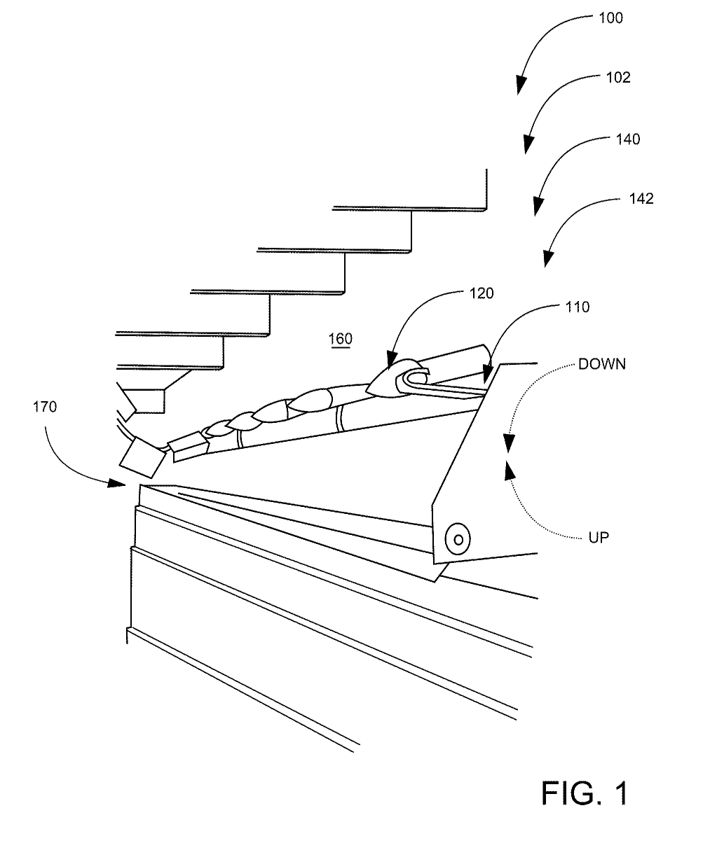

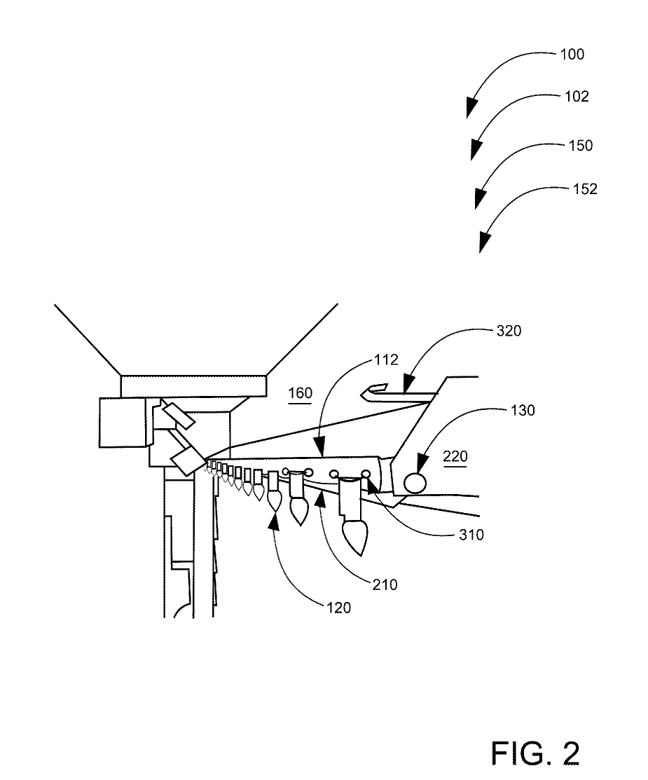

Referring to the drawings by numerals of reference there is shown in FIG. 1, festive light display assembly system 100 for use in hanging holiday lights 120 in concealed-up position condition 140 according to an embodiment of the present invention. The present invention preferably comprises: at least one retractable bar 110 having a plurality of strings of holiday lights attached 120 thereto (preferably hung adjacently or alternately hung extension-vertically therefrom—such as with icicle lights); and at least one hinge mechanism 130 coupled to retractable bar 110 permitting retractable bar 110 to be manipulated between concealed-up position 140 and display-down position(s) 150. Concealed-up position 140 as shown in FIG. 1 is employed in at least one non-use period such as non-festive occasions. Display-down position 150 as shown in FIG. 2 is employed in at least one in-use period festive occasion such as holidays including Christmas and others.

Within the present invention retractable bar 110 having a plurality of strings of holiday lights 120 attached thereto and hinge mechanism 130 comprise festive light display assembly system 100. Retractable bar 110 is removably secured behind rain gutters and fascia boards 160 of a building, as shown, for automatically displaying holiday lights 120 when in display-down position 150. To accomplish this, hinge mechanism 130 is able to be repeatedly manipulated manually or automatically (via a motorized means) by a user between display-down position 150, (for at least one display-use 152 during the holiday season thereby displaying holiday lights 150 for illumination-decorative purposes), and concealed-up position 140 thereby concealing retractable bar 110 for the remainder of the year in a non-use environmentally-protected location 142.

Hideaway holiday lights system 102 of festive light display assembly system 100 comprises retractable bar(s) 110 that conveniently fit behind rain gutters and fascia boards 160 for installing strands of holiday lights 120 that can be left in place year round in a substantially hidden location. In this way the present invention serves to prevent damage to holiday lights 120 caused by impact or environmental UV ray and other damage. After installation, the user can flip the light bars down during the holiday season (hereby enabling display-use 152) and then place them back in the storage position (non-use environmentally-protected location 142) where they can remain effectively hidden for the remainder of the year. This novel item may be available in several variations with slight structural differences, some of the various embodiments discussed herein, but all designs have virtually identical functioning of retractable bar(s) 110.

The following has been provided to enable manufacturing of an adjustable embodiment of the present invention. Festive light display assembly system 100 may comprise framing measuring approximately 2 inches high by 2 inches wide with an adjustable length of approximately 68 inches with an adjustable metal sheet covering. The framing may comprise metal, plastic or other suitable lightweight and weather-resistant material(s). The framing may be cut 2 inches in at the ends thereby enabling it to bend in at a 45-degree angle to make the left and right side of the frame 37 inches with an adjustable length of about 37 inches to 68 inches long. The device may comprise two channel bars 112, one being ⅝ inch by ⅜ inch and the other being 7/16 inch by ¾ inch both at 37 inches for adjustable length of about 37 inches to 68 inches. Both channel bars 112 may have ⅛ inch by 9⅙ inch long cuts every ¼ inch where holiday lights 120 may be mounted. A metal bar measuring approximately 2¾ inches long by ½ inch wide by ⅙ inch high may be bent at 1¾ inches to make a suitable 45 degree angle for channel bar to mount. ¼ inch by 1 inch bolts, light bar brackets, and 1¼ inch lock nuts may be used to mount to frame. A ½ inch spring steel lock bent at 1¼ inches may be used to hold the light bars up in the storage position (non-use environmentally-protected location 142). The present embodiment may be installed with a pull release that frees the device to flip down into display-down position 150. Upon reading this specification, it should be appreciated that, under appropriate circumstances, considering such issues as user preferences, design preference, structural requirements, marketing preferences, cost, available materials, technological advances, etc., other dimensions and arrangements such as, for example, other lengths, widths and heights, etc., may be sufficient.

Referring now to FIG. 2, a perspective view illustrating hideaway holiday lighting system 102 in display-down position 150 according to an embodiment of the present invention of FIG. 1.

As discussed above, retractable bar 110 for hanging holiday lights 120 (festive light display assembly system 100) comprises at least one mountable frame 210, mountable frame 210 and further comprising caps 220 in certain embodiments. Mountable frame 210 may comprise plastic since plastic is lightweight and substantially durable in-use, thereby providing a cost-effective light displaying means. In other embodiments mountable frame 210 may comprise sheet metal (ferrous or non-ferrous material, alloys or other). Upon reading this specification, it should be appreciated that, under appropriate circumstances, considering such issues as user preferences, design preference, structural requirements, marketing preferences, cost, available materials, technological advances, etc., other mounting arrangements and materials such as, for example, using composites, enclosed framed members, substantially enclosed framed members, frame may be mounted via nails, screws, adhesive, etc., may be sufficient.

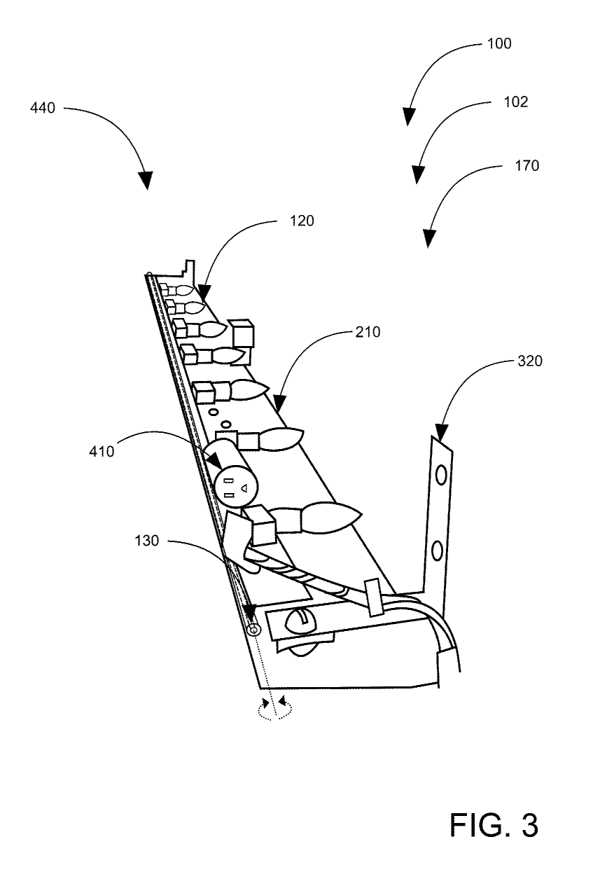

Referring now to FIG. 3, showing a perspective view illustrating retractable bar 110 for hanging holiday lights 120 according to an alternate embodiment of the present invention of FIG. 1.

Retractable bar 110 may comprise channel bar 112 for hanging holiday lights 120 which may further comprise slots 310. Slots 310 may comprise through-hole apertures wherein fasteners (such as zip ties) may be used to retain strings of holiday lights 120 which are securable therethrough. It should be appreciated that holiday lights 120 may be removed from strings/sockets and re-inserted as desired in certain embodiments. Slots 310 are approximately ⅛-inch by 9⅙-inch long cuts approximately every ¼-inch along a length of channel bar(s) 112. Using this dimensioning the user has found favorable to manipulate holiday lights 120 for maintenance procedures (tying, changing, etc.) and as an appropriate spacing when illumination-displaying holiday lights 120. In the present invention, light strings may be run through the interior of channel bar 112 (using it as a conduit that is a snap-together version wherein light strings may be disposed and holiday lights 120 draped downthrough openings) or outside, as shown. In this way the present embodiment may also protect light strings from UV damage, a further improvement and advantage.

L-shaped attaching members 320 may be used for fixedly-attaching retractable bar 110 to the rain gutters and/or fascia boards 160. In this way the present invention is suitably secured to prevent wind, rain and other environmental damage by holding secure festive light display assembly system 100.

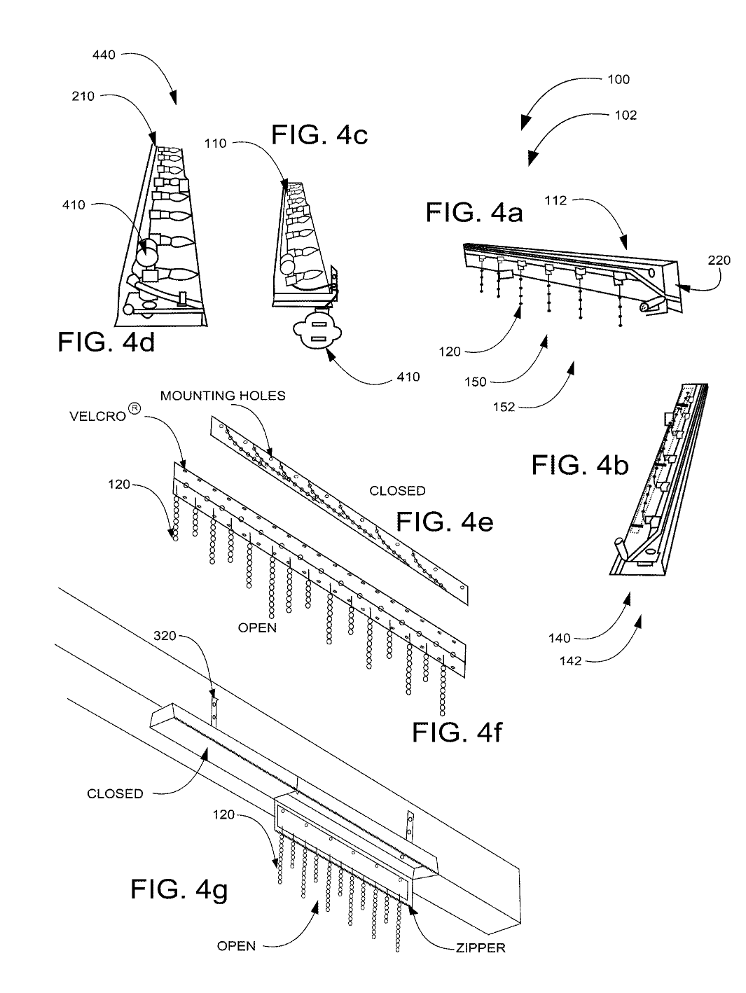

Referring now to FIGS. 4a-4g showing perspective views illustrating various embodiments of the present invention of FIG. 1, certain embodiments having outlet 410 others illustrating use of zippers, Velcro® (hook and loop fasteners) to render open/closed conditions (concealed-up position 140 and display-down positions 150).

Hideaway holiday lights system 102 may further comprise at least one electrical outlet 410 for providing alternate electrical transfer means to power other devices or to add on more strings of holiday lights 120. Hideaway holiday lights system 102 may also comprise at least one light storage bag, fasteners, as shown closed in FIG. 4e and again in FIG. 4b (light storage bag shown in dotted lines in FIG. 4b). Light storage bag and fasteners may be used to storingly-protect icicle versions of strings of holiday lights 120 during the remainder of the year (holiday off-season) in non-use environmentally-protected location 142 (shown in FIGS. 1 and 3).

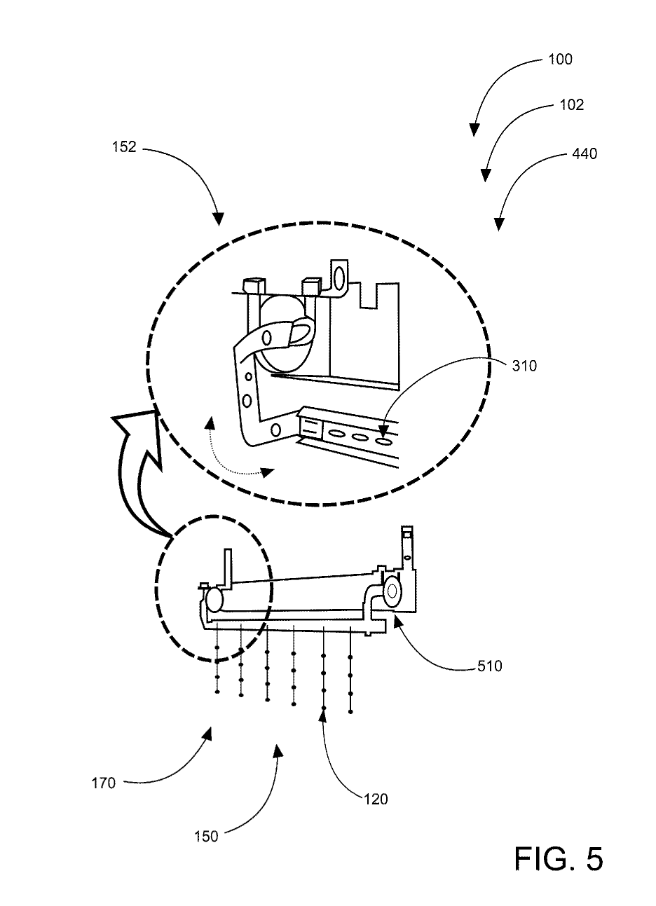

In alternate embodiments festive light display assembly system 100 may further comprise at least one switch and at least one electrical motor 510, thereby providing powering means for hinge mechanism 130, such that electrical motor 510 (shown in FIG. 5) is usable to manipulate hinge mechanism 130 repeatably between concealed-up position 140 and display-down position 150 and back to concealed-up position 140. In this way the present invention may be automated. In certain embodiments in high buildings, in hard-to-reach locations a timer may be used in conjunction with the switch and electrical motor 510 to activate the system. Wireless communication may also be used for remote-activation/deactivation in certain embodiments. In this way the present invention serves to promote safety and convenience for its users.

Hideaway holiday lights system 102 may be sold as kit 440 comprising the following parts: at least one retractable bar 110 for hanging holiday lights 120 at least one hinge mechanism 130; at least one connectable string or separately insertable hanging holiday light(s) 120; outlets 410; at least one light storage bag; fasteners (Velcro™, zip ties, snaps, buttons, clips or other); and at least one set of user instructions. Hideaway holiday lights system 102 and festive light display assembly system 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, parts may be sold separately, various strings of for example pumpkin-shaped lights, candles for New Year celebrations, icicle lights, kit may include rotating means (roller or other) whereby icicle lights versions of holiday lights 120 may be rolled up before stowing, etc., may be sufficient.

Referring now to FIG. 5, showing a perspective view illustrating another alternate embodiment having electrical motor 510 according to an embodiment of the present invention of FIG. 1.

Hinge mechanism 130 provides a rotating centerline whereby retractable bar 110 is rotatable between concealed-up position 140 (shown in FIG. 1) and display-down position(s) 150 respectively (shown in FIG. 2), either via manual or automatic means facilitated by electrical motor 510 in such embodiments. Retractable bar 110 is lockable into concealed-up position 140 and alternately lockable into display-down position 150. Hinge mechanism 130 may further comprise at least one pull release as discussed previously.

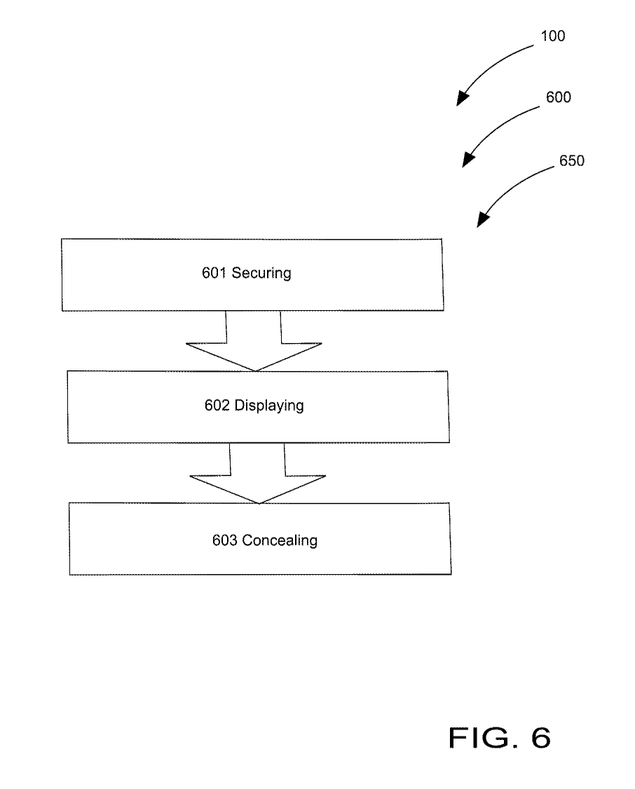

Referring now to FIG. 6, a flowchart 650 illustrating a method of use 600 for hideaway holiday lights system 102 according to an embodiment of the present invention of FIGS. 1-5. A method of using (at least hereby embodying method of use 600) a retractable bar 110 (of festive light display assembly system 100) for hanging holiday lights 120 comprising the steps of: step one 601 removably securing at least one retractable bar assembly 170 behind rain gutters and/or to fascia boards 160 of a building for automatically displaying a plurality of holiday lights 120 during at least one festive season; step two 602 flipping and thereby unstowing retractable bar assembly 170 in a display-down position 150 during festive season(s) thereby illumination-displaying the plurality of holiday lights 120; and step three 603 flipping retractable bar 110 (retractable bar assembly 170) back up into a stowed storage position (concealed-up position 140) thereby concealing said retractable bar 110 (retractable bar assembly 170) for a remainder of time (the year) in a non-use position. Use of zippers, Velcro® (hook and loop fasteners) to render open/closed conditions may also be employed. Upon reading this specification, it should be appreciated that, under appropriate circumstances, considering such issues as user preferences, design preference, structural requirements, marketing preferences, cost, available materials, technological advances, etc., other time increments such as, for example, seconds, minutes, days, part-days, seasons, years, etc., may be sufficient.

It should be noted that the steps described in the method of use can be carried out in many different orders according to user preference. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A retractable bar for hanging holiday lights assembly comprising:
at least one said retractable bar having a length with a plurality of strings of holiday lights adjacently-attached thereto along said length; and
at least one hinge mechanism coupled to said at least one retractable bar permitting said retractable bar to be manipulated between concealed-up and display-down positions;
wherein said at least one retractable bar is removably securable behind rain gutters and fascia boards of a building for automatically displaying said plurality of strings of holiday lights when in said display-down position; and
wherein said at least one hinge mechanism is able to be repeatedly manipulated by a user between said display-down position, for at least one display-use during the holiday season thereby displaying said plurality of strings of holiday lights for illumination-decorative purposes, and said concealed-up position, thereby concealing said retractable bar for the remainder of time in a non-use environmentally-protected location.

2. The retractable bar for hanging holiday lights assembly of claim 1 further comprising at least one electrical outlet, at least one light storage bag, fasteners, wherein said light storage bag and said fasteners are used to storingly-protect icicle versions of said strings of holiday lights during said remainder of the year in said non-use environmentally-protected location.

3. The retractable bar for hanging holiday lights assembly of claim 1 further comprising at least one switch.

4. The retractable bar for hanging holiday lights assembly of claim 1 further comprising at least one electrical motor.

5. The retractable bar for hanging holiday lights assembly of claim 4 wherein said electrical motor is usable to manipulate said hinge mechanism.

6. The retractable bar for hanging holiday lights assembly of claim 1 further comprises at least one mountable frame.

7. The retractable bar for hanging holiday lights assembly of claim 6 wherein said at least one mountable frame comprises plastic.

8. The retractable bar for hanging holiday lights assembly of claim 6 wherein said at least one mountable frame comprises sheet metal, said mountable frame further comprising caps.

9. The retractable bar for hanging holiday lights assembly of claim 1 wherein said at least one retractable bar comprises two channel bars.

10. The retractable bar for hanging holiday lights assembly of claim 9 further comprising slots.

11. The retractable bar for hanging holiday lights assembly of claim 10 wherein said slots comprise through hole apertures wherein fasteners to retain said strings of holiday lights are securable therethrough.

12. The retractable bar for hanging holiday lights assembly of claim 11 wherein said slots are approximately ⅛-inch by 9⅙-inch long cuts approximately every ¼-inch along a length of said channel bar(s) and provide a light string holder.

13. The retractable bar for hanging holiday lights assembly of claim 1 further comprising L-shaped attaching members for attaching said retractable bar to said rain gutters and/or said fascia boards.

14. The retractable bar for hanging holiday lights assembly of claim 1 wherein said hinge mechanism provides a rotating centerline whereby said retractable bar is rotatable between said concealed-up and said display-down positions.

15. The retractable bar for hanging holiday lights assembly of claim 1 wherein said retractable bar is lockable into said concealed-up position.

16. The retractable bar for hanging holiday lights assembly of claim 1 wherein said retractable bar is lockable into said display-down position.

17. The retractable bar for hanging holiday lights assembly of claim 1 wherein said hinge mechanism comprises at least one pull release.

18. A retractable bar assembly for hanging holiday lights comprising:
at least one retractable bar comprising two channel bars having slots with through hole apertures with approximately ⅛-inch by 9⅙-inch long cuts approximately every ¼-inch along a length of said channel bar(s) wherein fasteners to retain a plurality of strings of holiday lights are securable therethrough, said retractable bar is lockable into a concealed-up position and/or a display-down position;
at least one electrical outlet;
at least one electrical switch;
at least one electrical motor;
wherein said electrical outlet, said electrical switch are used to power said electrical motor;
at least one plastic mountable frame;
at least one light storage bag;
at least one light storage bag fastening device;
a plurality of L-shaped attaching members; and
at least one hinge mechanism with a pull release coupled to said at least one retractable bar permitting said retractable bar to be manipulated between said concealed-up and said display-down positions;
wherein said at least one retractable bar is removably secured behind rain gutters and fascia boards of a building in said plastic mountable frame for automatically displaying said plurality of strings of holiday lights when in said display-down position;
wherein said at least one hinge mechanism is able to be repeatedly manipulated by a user between said display-down position, for at least one display-use during the holiday season thereby displaying said plurality of strings of holiday lights for illumination-decorative purposes, and said concealed-up position thereby concealing said retractable bar for a remainder of time in a non-use environmentally-protected location, said user may manipulate said hinge mechanism via manual and/or automated means;
wherein said hinge mechanism provides a rotating centerline whereby said retractable bar is rotatable between said concealed-up and said display-down positions;
wherein said electrical motor is usable to automatically manipulate said hinge mechanism;
wherein said plurality of L-shaped attaching members are used to attach said retractable bar to said rain gutters and/or said fascia boards;
wherein said retractable bar is lockable into said concealed-up position; and
wherein said retractable bar is lockable into said display-down position.

19. The retractable bar assembly for hanging holiday lights of claim 18 further comprising a kit including: said retractable bar for hanging holiday lights; said at least one hinge mechanism; said mountable frame; said hanging holiday lights; said light storage bag; said fasteners and a set of user instructions.

20. A method of using a retractable bar for hanging holiday lights assembly comprising the steps of:
removably securing at least one retractable bar behind rain gutters and fascia boards of a building for automatically displaying a plurality of holiday lights during at least one festive season;
flipping and thereby unstowing said retractable bar into a display-down position during said festive season thereby illumination-displaying said plurality of holiday lights; and
flipping said retractable bar back up into a stowed storage position thereby concealing said retractable bar for a remainder of time in a non-use position.
